(19) United States
(12) Patent Application Publication
(10) Pub. No.: US 2008/0198222 A1
(43) Pub. Date: Aug. 21, 2008

(54) System and method for tele-presence

(76) Inventor: Sanjay Gowda, Newport News, VA (US)

Correspondence Address: WILLIAMS MULLEN, 222 CENTRAL PARK AVENUE, SUITE 1700, VIRGINIA BEACH, VA, 23462, US

(21) Appl. No.: 12/012,603

(22) Filed: Feb. 4, 2008

Related U.S. Application Data
(60) Provisional application No. 60/899,293, filed on Feb. 2, 2007.

(51) Int. Cl. H04N 7/18

(52) U.S. Cl. 348/62

(57) ABSTRACT

A computer based process for providing a visually impaired subject with multi-modal (local, remote, human-aided, computer-aided), multi-sensory (hearing, touch), information about the subject's physical environment is disclosed, involving identifying at least one guide; identifying at least one subject; establishing a communication connection between the guide and the subject; capturing information about the at least one subject's physical environment; presenting the information about the at least one subject's physical environment to the at least one guide; capturing the guide's response to the at least one subject's physical environment; and communicating the guide's response to the at least one subject. The system may involve a guide computer, a user mounted information collection system for receiving visual signals, audio input signals, and a user mounted information dispensing system for dispensing a haptic signal and an audio output signal. A bi-directional communication system operably linked between the computer, the information collection system, and the information dispensing system enables the computer to receive visual and audio signals from the user and communicates audio output signals from the guide to the user.

### CROSS REFERENCE TO RELATED APPLICATIONS

The present application claims priority from U.S. Provisional Application Ser. No. 60/899,293, which was filed on Feb. 2, 2007, which is hereby incorporated by reference.

### STATEMENT REGARDING FEDERALLY SPONSORED RESEARCH OR DEVELOPMENT

Not applicable; the present invention was not federally sponsored or developed.

### BACKGROUND OF THE INVENTION

A variety of mobility tools exist for individuals with visual impairments. Choice of mobility tool depends on requirements of the individual and the environments in which they travel. Each of the tools has advantages and disadvantages. There are about four types of mobility tools available for individuals with visual impairments. The first is the human guide. The other three most accepted and proven types of mobility systems or tools include canes, Pal guides, and electronic travel aids (ETAs). The function of mobility systems or tools is to provide information about the travel path advance of entrance into a space.

Human guides provide many advantages for the visually impaired. They provide excellent feedback to the visually impaired, and also provide a socialization aspect. The major disadvantage of a Human Guide is the dependency on a specific individual.

### SUMMARY OF THE INVENTION

The Present invention seeks to achieve the advantages of each of these tools while allowing maximum flexibility to the user.

The present invention also addresses issues of the homebound. Isolated from society due to physical disability or other limitations, the Present invention seeks to provide these individuals with a mechanism to be an active/productive member of society (e.g., volunteer, earn income, etc.). The social networking aspect of the proposed website strongly promotes teamwork for the visually impaired and physically disabled.

The present invention is a system for exercising telepresence, comprising a computer having a storage and a user interface; an information collection system comprising a visual input device capable of receiving a visual signal and a microphone capable of receiving an audio input signal, wherein the information collection system is capable of being mounted on an individual; an information dispensing system comprising a haptic feedback device capable of sensing a physical environment and dispensing a haptic signal and a speaker capable of dispensing an audio output signal, wherein the information dispensing system is capable of being mounted on an individual; a bi-directional communication system operably linked between the computer, the information collection system, and the information dispensing system, so as to enable the computer to receive visual and audio signals from the information collection system and to communicate audio output signals to the information dispensing system; and a computer program for communicating the visual signal and audio input signal to the user interface and for receiving user response from the user interface and converting it to an audio output signal.

Optionally, the computer may be in communication with a computer network, and the computer program further comprises an internet portal enabling access by multiple users.

The present invention further comprises a method for implementing the steps of the foregoing system, as further described herein.

A computer based process for providing a visually impaired subject with multi-modal (local, remote, human-aided, computer-aided), multi-sensory (hearing, touch), information about the subject's physical environment, comprising the steps of identifying at least one guide; identifying at least one subject; establishing a communication connection between the guide and the subject; capturing information about the at least one subject's physical environment; presenting the information about the at least one subject's physical environment to the at least one guide; capturing the guide's response to the at least one subject's physical environment; and communicating the guide's response to the at least one subject.

### BRIEF DESCRIPTION OF THE SEVERAL VIEWS OF THE DRAWINGS

FIGS. 1 illustrates an aspect of the present invention.

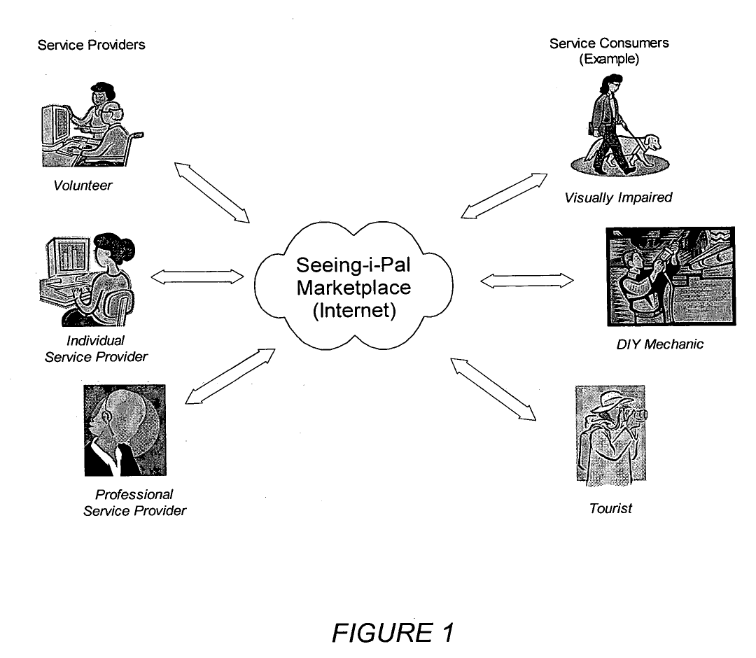

FIG. 2 illustrates an aspect of the present invention.

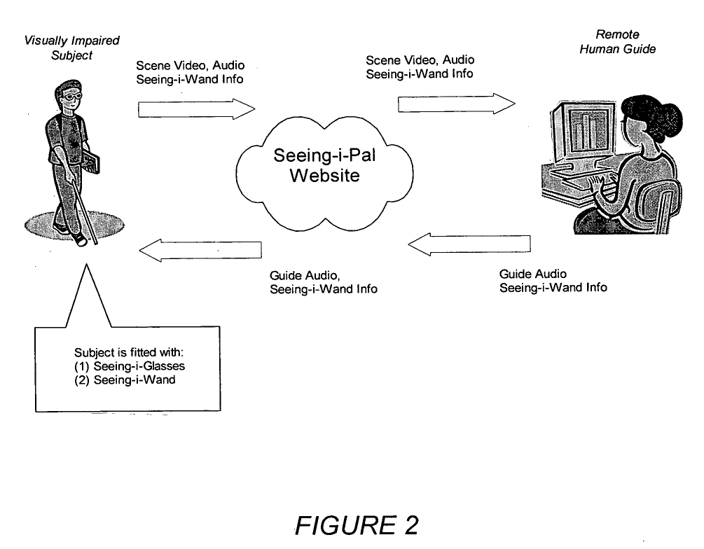

FIG. 3 illustrates an aspect of the present invention.

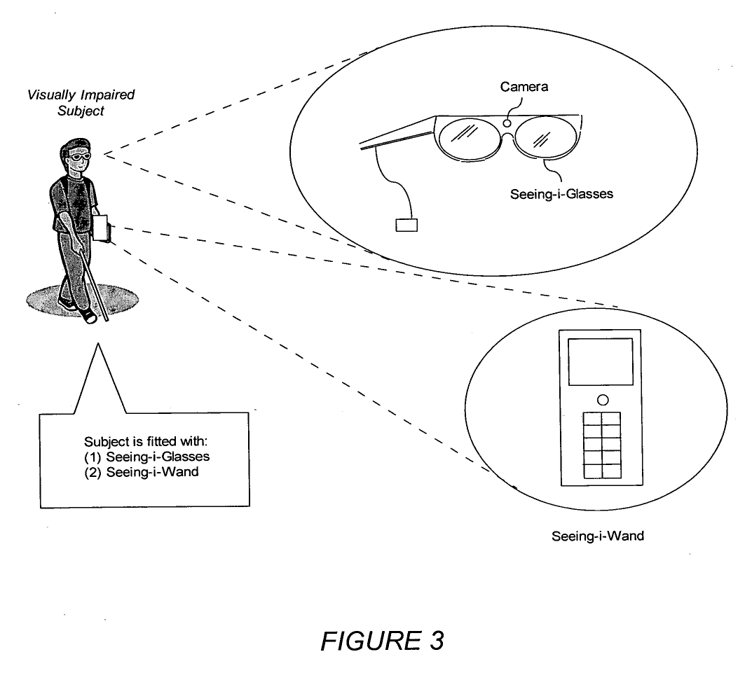

### DETAILED DESCRIPTION OF THE INVENTION

The present invention is a novel system which facilitates navigation for the visually impaired. An aspect of the invention is the use of technology in various fields to provide the visually impaired with a multi-modal (local, remote, human-aided, computer-aided), multi-sensory (hearing, touch) capability to navigate surroundings and to improve overall quality of life. Based on the concept of telepresence, the present invention provides the visually impaired with a telepresent Human Guide. This system seeks to link human beings together for their common benefit.

At its core the present invention involves two participants: (1) a visually impaired subject (Subject), and (2) a ‘Human Guide’ (Guide). The (visually impaired) Subject and the Guide are connected with each other via a collaborative web-site. The Subject is fitted with Stereoscopic (or monoscopic) glasses (connected to a wearable computer), a microphone/earpiece, and a device called the “Seeing-i-Wand”. The Guide is equipped with a personal computer (preferably with stereoscopic viewing capability). Employing the concept of telepresence, the Guide is able to help the subject better navigate and interact with his/her environment.

A computer based process for providing a visually impaired subject with multi-modal (local, remote, human-aided, computer-aided), multi-sensory (hearing, touch), information about the subject's physical environment is disclosed, involving identifying at least one guide; identifying at least one subject; establishing a communication connection between the guide and the subject; capturing information about the at least one subject's physical environment; presenting the information about the at least one subject's physical environment to the at least one guide; capturing the guide's response to the at least one subject's physical environment; and communicating the guide's response to the at least one subject. The system may involve a guide computer, a user mounted information collection system for receiving visual signals, audio input signals, and a user mounted information dispensing system for dispensing a haptic signal and an audio output signal. A bi-directional communication system operably linked between the computer, the information collection system, and the information dispensing system enables the computer to receive visual and audio signals from the user and communicates audio output signals from the guide to the user.

The present invention is a system for exercising telepresence, comprising a computer having a storage and a user interface; an information collection system comprising a visual input device capable of receiving a visual signal and a microphone capable of receiving an audio input signal, wherein the information collection system is capable of being mounted on an individual; an information dispensing system comprising a haptic feedback device capable of sensing a physical environment and dispensing a haptic signal and a speaker capable of dispensing an audio output signal, wherein the information dispensing system is capable of being mounted on an individual; a bi-directional communication system operably linked between the computer, the information collection system, and the information dispensing system, so as to enable the computer to receive visual and audio signals from the information collection system and to communicate audio output signals to the information dispensing system; and a computer program for communicating the visual signal and audio input signal to the user interface and for receiving user response from the user interface and converting it to an audio output signal.

The system can be described by considering the basic method of the system. This workflow method may include the following aspects:
1. Connecting the subject and the Guide: A social networking site will be developed that provides a robust service for Human and computer-aided living/navigation.
2. Capturing the subjects Environment: The environment of the visually impaired Subject is captured via Seeing-i-glasses (stereo cameras mounted to glasses with a microphone/earpiece) connected to a wearable computer.
3. Processing the environment and helping the visually impaired “see” (Computer Aided and Human-Aided): Utilizing the stereoscopic (or monoscopic) video captured by the Seeing-i-Glasses, the video is processed both locally (by a wearable computer) and remotely (by a human). Once the video (and Subject's audio) is processed, feedback (audio, haptic) is given to the subject to help the subject interact with his/her environment.

The multi-modal, multi sensory nature of the present invention allows people to utilize the system in a way that works best for a particular environment, for a particular activity, and for a particular situation. This system seeks to improve the subject's mental model of the physical environment while providing maximum flexibility and comfort.

The system aims to deploy a public social networking site for the disabled to provide help, foster an environment for caring, and provide work opportunity for immobile and housebound. It is also envisioned that the collaborative site becomes a site to encourage socialization. The benefits of this system are many. The system seeks to aid the visually impaired in daily life activities, seeks to empower the Guide, and create a social networking site that fosters the human spirit.

### SUMMARY OF ASPECTS OF THE INVENTION

The overall process used to provide an individual with telepresence services. The Seeing-i-Pal process is enabled by the “Seeing-i-Pal” system.

A collaborative, service-based (rated), website, based on the philosophy of social networks (i.e., social networking website), that enables a marketplace for telepresence services.

A light-weight, hand-held, hardware device that enhances the interactivity of the “Seeing-i-Pal” system. The system provides: (1) Haptic feedback (tactile sensation) and auditory feedback, (2) provides a pointing device that enables communication with a Human Guide or computer system, and (3) provides a menu system for the Subject to interact w/the Present invention.

Light-weight glasses equipped with: (1) stereoscopic cameras (or monoscopic camera), (2) a microphone, and (3) an ear piece. The Seeing-i-Glasses are connected to a wearable computer and provide “vision” for the “Seeing-i-Pal” system.

The following is an overview of the present invention. The inventor has identified the need for a collaborative system enabling a high degree of interactivity and immersion: a multi-modal, multi-sensory, internet-based marketplace enabling telepresence collaboration is a solution.

An aspect of the invention is an infrastructure would allow individuals to provide telepresence services over the internet. These services could be:

Volunteer-based (individual or professional)

Individual-based (providing telepresence services for an agreed upon cost)

Professional services (cost-based)

A significant motivation in the creation of this marketplace is to enable people (across the world—volunteer or paid) to lend their expertise to others who need help. The system of the present invention seeks to link human beings together for common benefit.

The multi-modal (video, audio, haptic) and multi-sensory (sight, hearing, touch) nature of our proposed system provides the flexibility to achieve telepresence in various ways. More importantly, it allows people to provide and realize services with different levels of hardware, software, and interactivity. The present invention allows users to utilize the system in a way that works best for a particular environment, for a particular activity, and for a particular situation.

This technology has applicability across many domains. There are many usage scenarios where having a telepresence capability/marketplace would be beneficial:

Human Guide services for the visually impaired: Could be used to provide a visually impaired person with a telepresent human guide. The guide could be housebound (e.g., paraplegic).
1. Tour Services: Could provide help with directions, identifying points-of-interest, and increased safety.
2. Museum Services: Could provide help with navigation and description of museum artifacts.
3. Point-Of-View Tube: Could provide a service to post/share/view video from an individual's point-of-view. This could be used for capturing and sharing personal memories, activities, etc.
4. Repair services—Could provide help with fixing cars, household items, etc.
5. Medical services—Could be utilized to help a nurse and doctor collaborate (e.g., while the doctor is away).
6. Entertainment/Sports
7. Linguistics—Could provide improved translation services (communication is both verbal and visual)
8. Government—Could provide help with training and operations.
9. Academic—Could provide help with schoolwork, labs, etc.

One embodiment is a one-way telepresence collaboration (i.e., one person is equipped with glasses; the other is working at a desktop PC). As technology progresses (glasses, bandwidth, tracking), we envision a two-way telepresence, augmented reality based platform. In the near term, we seek to drive out this technology and take it to market to help the visually impaired. The following pages discuss an embodiment that is focused on a providing aid the visually impaired. Howeverr the present invention should not be construed to be so limited.

### SUMMARY

“Seeing-i-Pal” Process: The overall process used to provide a visually impaired subject with a multi-modal (local, remote, human-aided, computer-aided), multi-sensory (hearing, touch), capability to understand and interact with his/her environment. The Seeing-i-Pal process is enabled by the “Seeing-i-Pal” system. A primary mode of the system focuses on bi-directional communication between the visually impaired subject (“Subject”), and the remotely located Human Guide (“Guide”).

“Seeing-i-Pal” Website: A collaborative, service-based (rated), website for the visually impaired based on the philosophy of social networks (i.e., social networking website). The website will enable and facilitate bi-directional communication between the visually-impaired “Subject” and Human “Guide”.

“Seeing-i-Wand”: A light-weight, hand-held, device that: (1) provides Haptic feedback (tactile sensation) and auditory feedback to the visually impaired Subject, (2) provides a pointing device that enables communication with a Human Guide or computer system, and (3) provides a menu system for the Subject to interact w/the Present invention.

“Seeing-i-Glasses”: Light-weight glasses equipped with: (1) stereoscopic cameras (or monoscopic camera), (2) a microphone, and (3) an ear piece. The Seeing-i-Glasses are connected to a wearable computer.

The system may be described by considering the basic workflow of the system. This workflow captures the key innovations of the proposed system:

Connecting the visually impaired Subject and the Guide

Capturing the Subjects Environment

Processing the environment and helping the visually impaired “see”

A computer based process for providing a visually impaired subject with multi-modal (local, remote, human-aided, computer-aided), multi-sensory (hearing, touch), information about the subject's physical environment, comprising the steps of identifying at least one guide; identifying at least one subject; establishing a communication connection between the guide and the subject; capturing information about the at least one subject's physical environment; presenting the information about the at least one subject's physical environment to the at least one guide; capturing the guide's response to the at least one subject's physical environment; and communicating the guide's response to the at least one subject.

### Connecting the Team (Visually Impaired Subject and the Guide): A Collaborative Website Based on Social Networking

A significant innovation of the proposed system is the mechanism for connecting the visually impaired Subject and the Human Guide (both for setup and interaction/navigation). It is envisioned that the website will enable the connection (peer-to-peer or multi-cast) between the subject and the helper. Characteristics of the system include:

Defined Lexicon—In the human guided mode, the system will allow for both unstructured and structured communication. It is envisioned that unstructured mode will be free-form communication (possibly between friends). A defined Lexicon will form the basis of structured communication between the Subject and Guide (e.g., professional services).

Training—The system will provide an online training capability to train Guides. The training system will enable the Guide to learn more standard ways of interaction. Just as becoming a Human Guide is not trivial; a telepresent human guide will face similar problems. Learning the proper techniques through training will be possible.

Rating System—A system will in place that helps quantify skill-level and overall usefulness of the Guide (and respective service). It is envisioned that this system will be a rating system where Subjects can provide reviews/information of Guides (and vice versa). Any individual seeking to provide a service would have a rating.

Access to Professional Guide services—It is envisioned that professional navigation companies would work through the discussed website to provide/advertise Guide services.

Interactive viewing application (voice mode, mouse mode)—As the video is streamed to the Guides workstation; an interactive window will allow the Guide to select items in the Subject's field of view. This allows the Guide to give non-verbal feedback (through the Seeing-i-Wand) to the Subject.

Social Networking: It is envisioned that this website will be a central mechanism to connect people together with common needs, services, and interests. (e.g., homebound, senior citizens, etc.)

### Capturing the Subjects Environment

It is envisioned that the visually impaired subject will wear a light-weight pair of glasses fitted with Stereoscopic (or monoscopic) Cameras and a Microphone/Earpiece. The glasses will be connected to a wearable computer (Wi-Fi enabled) fitted on the Subject. The Stereoscopic video (left eye, right eye) represents the visually impaired subject ‘sees’. The Visually impaired subject also has the option of being fitted with a handheld device (Seeing-i-Wand) that serves as an input/output device for the See-I-Pal system. The Seeing-i-Wand provides haptic feedback to the subject. The Seeing-i-Wand also provides a basic menu system and pointing capability (e.g., Virtual Cane).

Helping the Visually impaired “see”: Three modes

Once the subject's vision is captured the video provides the basis for the subjects ‘sight’. The video is then processed in one or more ways:

Locally processed, Haptic Feedback

Locally processed, Auditory Feedback

Remotely processed, Voice and Haptic Feedback

These modes are described in detail below:

Locally processed, Haptic Feedback—Using image processing of the input video, a device called the “Seeing-i-Wand” provides haptic (vibration of different frequencies and amplitude) feedback to the user. The visually impaired subject can use the wand to “feel” the environment. The device could be handheld or attached to the arm/hand for ease of use. It is envisioned that the Seeing-i-Wand would also is equipped with a simple interface for communication and instruction. The Seeing-i-Wand would use basic tracking technology (e.g., image processing, sonar, laser, accelerometer, gyros).

Locally processed, Auditory Feedback: “Seeing with your ears”, Peter Meijer. Miejer, et. Al. have developed a technology (vOICe) allowing the representation of visual information with sound. Other modes of aud. feedback are also possible.

Remotely processed, Voice and Haptic Feedback—In this mode, the stereoscopic (or monoscopic) video is streamed over the internet to the Guide sitting at his/her computer. In stereoscopic mode, the video is combined into stereoscopic video allowing the helper to see and hear what the visually impaired subject sees in full 3-dimensions. If the Guide is not equipped with a stereoscopic display capability, the Guide can aid the subject in 2D mode. The Guide is then able to help the visually impaired subject navigate and interact with his/her surroundings. In addition to voice descriptions, the Guide is able to point to an object in the “virtual” scene with a mouse and direct the visually impaired subject to a specific object of interest. Here, the Seeing-i-Wand can give the Subject cues (i.e., vibrations) for guidance. For example, the vibration amplitude could be attenuated based on distance from the object of interest.

Exemplary system components may include the following embodiments.

For the visually impaired Subject:
a. Wi-fi enabled Wearable Computer (would leverage existing technology)
b. Stereoscopic (or monoscopic) cameras mounted to eyeglasses with attached microphone and earpiece (leverage/modify existing technology)
c. Seeing-i-Wand (to-be developed)

For the Guide: PC with (or without) stereoscopic viewing hardware and Software

Web-based Collaborative Site with integrated, interactive, telepresence software

Basic Usage of the System may be as follows:

Registration, setting up a Session (transacting):

Subject (with the aid of a Helper) logs onto the Collaborative Website to create a profile. The Subject is also able to call a direct number to register for the site.

The Subject has the ability to manage helpers and create a schedule of required services (again, with the aid of a Helper or the site Operator).

The Guide logs on to the website and registers for the site and creates a profile. The Guide specifies whether he/she is a volunteer or a paid service provider.

The Guide selects sessions to serve or has been selected by the Subject.

Preparing for connection:

Subject puts on glasses, wearable computer, and Seeing-i-Wand.

Subject activates the session by calling (quick-dial from phone/wand). Subject is able to call directly to site operator to connect to a Guide if no session is set-up.

Guide logs onto the website and clicks on the scheduled session. The interactive viewport executes, and the Guide is ready to provide service:
a. If equipped with stereoscopic capability, interact in 3D.
b. If not equipped with monoscopic capability, interact in 2D.

The Subject and Guide connect, greet, and are ready for interaction.

Navigation/Interaction:

Visually impaired Subject:
a. The subject chooses which of the three modes he/she wished to operate in: (Local Haptic, Local Audio, Remote Navigation)
b. The subject goes about normal activity interacting with the Guide when needed. The Seeing-i-Wand provides the ability to switch between modes, muted audio, muted video, etc. (Wand gestures could also be used).
c. The Seeing-i-wand also provides a pointing device that can used to interact/communicate with the Guide. (The pointing device could also be implanted in the Seeing-i-Glasses).

Guide:
a. Using the Interactive Vision Viewport, the Guide (based on training, lexicon, etc.) is able to aid the subject in daily activities.

b. By selecting (using mouse or input device) a certain ‘object’ or ‘direction’ of interest, the Guide is able to provide haptic feedback to the Subject utilizing the See-I-Wand. For example, vibration amplitude and frequency will vary with distance from the object.

Payment/Rating/Feedback

If a payment agreement has been setup, the payment transaction is processed. If the aid is provided as a volunteer, hours logged will be noted. These hours could be used as tax deductions or paid by funded institutions (or government).

The visually impaired Subject is able to enter feedback/information for each Guide (and vice versa). This feedback will serve as input for the rating system.

This invention has been described in detail with particular references to certain embodiments. The above examples and embodiments should be considered to be illustrative and in no way limiting of the present invention. Thus, while the description above refers to particular examples, and embodiments, it will be understood that many modifications may be made without departing from the spirit thereof.

What is claimed is:

1. A system for exercising telepresence, comprising:
a computer having a storage and a user interface;
an information collection system comprising a visual input device capable of receiving a visual signal and a microphone capable of receiving an audio input signal, wherein the information collection system is capable of being mounted on an individual;
an information dispensing system comprising a haptic feedback device capable of sensing a physical environment and dispensing a haptic signal and a speaker capable of dispensing an audio output signal, wherein the information dispensing system is capable of being mounted on an individual;
a bi-directional communication system operably linked between the computer, the information collection system, and the information dispensing system, so as to enable the computer to receive visual and audio signals from the information collection system and to communicate audio output signals to the information dispensing system; and
a computer program for communicating the visual signal and audio input signal to the user interface and for receiving user response from the user interface and converting it to an audio output signal.

2. The system of claim 1, wherein the computer is in communication with a computer network, and the computer program further comprises an internet portal enabling access by multiple users.

3. A computer based process for providing a visually impaired subject with multi-modal (local, remote, human-aided, computer-aided), multi-sensory (hearing, touch), information about the subject's physical environment, comprising the steps of:
identifying at least one guide;
identifying at least one subject;
establishing a communication connection between the guide and the subject;
capturing information about the at least one subject's physical environment;
presenting the information about the at least one subject's physical environment to the at least one guide;
capturing the guide's response to the at least one subject's physical environment; and
communicating the guide's response to the at least one subject.
